(19) United States
(12) Patent Application Publication
(10) Pub. No.: US 2010/0100719 A1
(43) Pub. Date: Apr. 22, 2010

(54) METHOD FOR REDUCING BOOTING TIME AND COMPUTER USING THE SAME

(76) Inventors: Yu-Guang CHEN, Taipei (TW); Chong-Kim Chan, Taipei (TW); Hsin-Chung Yu, Taipei (TW)

Correspondence Address: Muncy, Geissler, Olds & Lowe, PLLC, P.O. BOX 1364, FAIRFAX, VA, 22038-1364, US

(21) Appl. No.: 12/543,136

(22) Filed: Aug. 18, 2009

(30) Foreign Application Priority Data
Oct. 17, 2008 (TW) 097140067

(51) Int. Cl. G06F 9/00

(52) U.S. Cl. 713/2; 713/320

(57) ABSTRACT

The invention provides a method for reducing booting time and a computer using the same. The method includes the following steps. The computer is shut down. After the step of shutting down the computer, the computer is booted up to make the computer enter into a power-saving mode. Thus, when a user performs an operation to boot up the computer, the computer resumes a normal state from the power-saving mode.

### CROSS REFERENCE TO RELATED APPLICATIONS

This Non-provisional application claims priority under 35 U.S.C. §119(a) on Patent Application No(s). 097140067 filed in Taiwan, Republic of China on Oct. 17, 2008, the entire contents of which are hereby incorporated by reference.

### BACKGROUND OF THE INVENTION

1. Field of Invention

The invention relates to a method applied to a computer and, more particularly, to a method for reducing booting time and a computer using the same.

2. Related Art

With the development of the information technology, computers have been widely accepted and used by users. During a conventional booting process of a computer, the computer first loads a basic input/output system (hereinafter called “BIOS”) after the computer is powered on. The BIOS would execute a plurality of operations such as performing a power-on self-test (hereinafter called “POST”), detecting hardware, installing drivers, loading an operating system (hereinafter called “OS”) and so on.

However, the booting time of the operating system greatly increases since the operating system of the computer becomes huger and some application programs are automatically started in the booting process, and therefore, the users have to spend a lot of time on waiting the finish of the booting process. It is inconvenient for the users.

### SUMMARY OF THE INVENTION

One objective of the invention is to provide a method for reducing booting time and a computer using the same to improve the operating performance of the computer.

The invention provides a method for reducing booting time of a computer. The method includes the following steps. The computer is shut down. After shutting down the computer, the computer is rebooted. The computer is then made to enter into a power-saving mode and resumes a normal state from the power-saving mode while a user performs an operation to boot up the computer.

The invention further provides a method for reducing booting time of a computer. The method includes the following steps. The computer is shut down. After shutting down the computer, the computer is rebooted and then a state of a set value of the computer is identified. If the set value corresponds to a power-saving mode, the computer is made to enter into the power-saving mode according to the set value and resumes a normal state from the power-saving mode while a user performs an operation to boot up the computer.

According to an embodiment of the invention, the power-saving mode may be a standby mode or a hibernation mode.

According to an embodiment of the invention, the method in the invention may further include the steps of receiving a set value of the power-saving mode and storing the set value to a secondary storage device or a basic input/output system (BIOS) of the computer, and further the computer is made to enter into the power-saving mode according to the set value.

The invention further provides a computer capable of reducing booting time. The computer includes an operating system. When an instant boot program is executed, a set value corresponding to a power-saving mode may be set. According to the set value, the operating system makes the computer enter into the power-saving mode after the computer is rebooted.

According to the aforementioned, the computer is rebooted and enters into the power-saving mode after shutting down, and therefore, the computer resumes a normal state from the power-saving mode and enters into an operating mode while a user boots up the computer. Most boot programs can be omitted so that the booting time of the computer is greatly reduced for achieving an instant boot effect.

In addition, the operating mode, into which the computer enters after booted from the power-saving mode using the method disclosed here, is the system state when the users do not start any application. Thus, the released memory can be sufficiently used by the users to improve processing performance of the computer.

These and other features, aspects, and advantages of the present invention will become better understood with regard to the following description, appended claims, and accompanying drawings.

### BRIEF DESCRIPTION OF THE DRAWINGS

FIG. 1 is a flowchart of a method for reducing booting time according to an embodiment of the invention;

FIG. 2 is a flowchart of a method for reducing booting time according to another embodiment of the invention;

FIG. 3 is a flowchart of a method for reducing booting time according to a preferred embodiment of the invention; and

FIGS. 4A-4C are flowcharts of a method for reducing booting time according to another preferred embodiment of the invention.

### DETAILED DESCRIPTION OF THE INVENTION

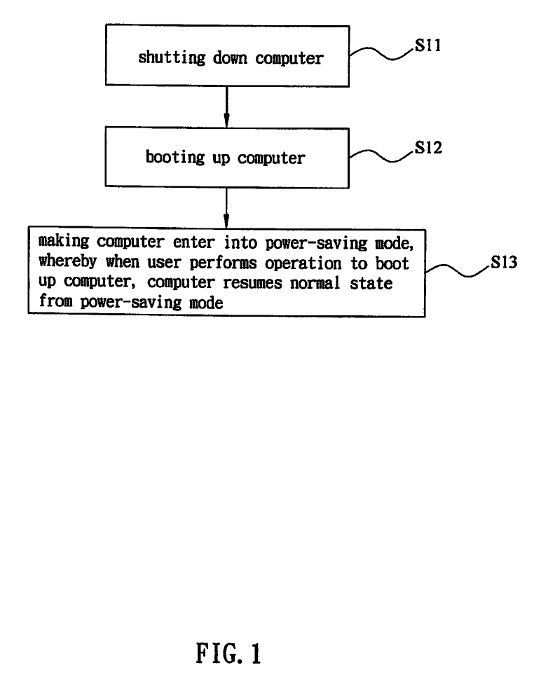

FIG. 1 is a flowchart of a method for reducing booting time of a computer according to an embodiment of the invention. The method includes steps S11 to S13. Before the embodiment of the invention is described, pluralities of modes of a computer are further described hereinbelow. At first, operating mode (hereinafter called “S0”): In the S0 mode, the computer is in a normal booting state, and the central processing unit (hereinafter called “CPU”) and the application programs are running. Second, standby mode (suspend to RAM, hereinafter called “S3”): In the S3 mode, the computer stores the operating states of the operating system and the application programs to the memory which is still powered on. Third, hibernation mode (suspend to disk, hereinafter called “S4”): In the S4 mode, the computer stores the operating states of the operating system and the application programs to a non-volatile memory (such as a hard disk drive). Fourth, soft off mode (hereinafter called “S5”): In the S5 mode, the computer is in a normal shutdown state, and the power of the computer is still provided by an external alternating current.

According to a preferred embodiment of the presented invention, the computer may be a desk-top computer, a notebook computer, a handheld computer, or any other computer devices such as a personal digital assistant, a mobile communication device, or a navigation device.

Furthermore, the kind of the operating system used in the computer is not limited in the present invention, and it may be a Microsoft Windows operating system, a Linux operating system, a Mac operating system, or any other operating systems such as a mobile operating system.

According to an embodiment of the presented invention, the method for reducing booting time of a computer can be realized by an instant boot program. The instant boot program may be existed in any form such as an optical disk or a program file on the Internet. And then the user can obtain the instant boot program and use it by installing it on the computer. The instant boot program, moreover, can also be applied to the computer by firmware or hardware. The firmware may be realized by recording the instant boot program into a memory (such as an EEPROM), and the hardware may be an application-specific integrated circuit (ASIC).

Afterwards, referring to FIG. 1, the embodiment of the invention is described hereinbelow.

Step S11: Shut down the computer. The step of shutting down the computer is based on the step of receiving a shutdown event. The shutdown event is generated from operations to an operating system, the instant boot program, or the hardware or peripheral devices by a user. Furthermore, pluralities of operations are included in the step of shutting down the computer such as clearing original information, releasing the memory, and storing the un-stored files. The above operations in the step of shutting down the computer are only shown as examples, however, other conventional shutdown programs can be further included.

Step S12: Reboot the computer. More importantly, the computer is rebooted after the computer is shut down. The step of rebooting the computer may include the step of loading an operating system, for example, loading the operating system into a random access memory (RAM) from a hard disk drive. In addition, the step of rebooting the computer further includes the following steps, for example, BIOS is loaded, a power-on self-test (POST) such as checking whether the states of the central processing unit (CPU) and each controller are normal is performed, initialization such as initializing the memory, the chipset on the motherboard, the display card, the peripheral devices, detecting the hardware and installing drivers is performed , a set value of the system such as basic settings for each component included a display, a keyboard, a processor, a memory and so on is recorded and a runtime program library such as an interrupt runtime program called by the operating system or application programs is provided.

Step S13: Make the computer enter into a power-saving mode. According to an embodiment of the invention, the user can select the S3 mode or the S4 mode as the power-saving mode. In general, the computer stores the operating states of the operating system and different kinds of the application programs to the memory under the S3 mode which is still powered on. In other respects, the computer stores the operating states of the operating system and different kinds of the applications to the non-volatile memory (such as a hard disk drive) under S4 mode. However, according to the embodiment of the presented invention, the operating states stored in the power-saving mode are the same as the system status wherein the user does not operate any application programs because the computer was made to enter into the power-saving mode after rebooted.

According to the aforementioned, the computer may resume a normal state from the power-saving mode while the user performs an operation such as pressing a power button to boot up the computer. At that moment, the state of the computer is the same as the system state wherein the user does not operate any application programs. It is important to notice that general boot programs such as loading a BIOS, performing a POST, performing initialization, recording a set value of the system, providing a runtime program library, and loading the operating system will not be executed while the computer resumes the operating mode from the power-saving mode. The computer only needs to make the operating states stored in the memory or in the hard disk drive stored back to the original positions, and therefore, the booting time can be greatly reduced.

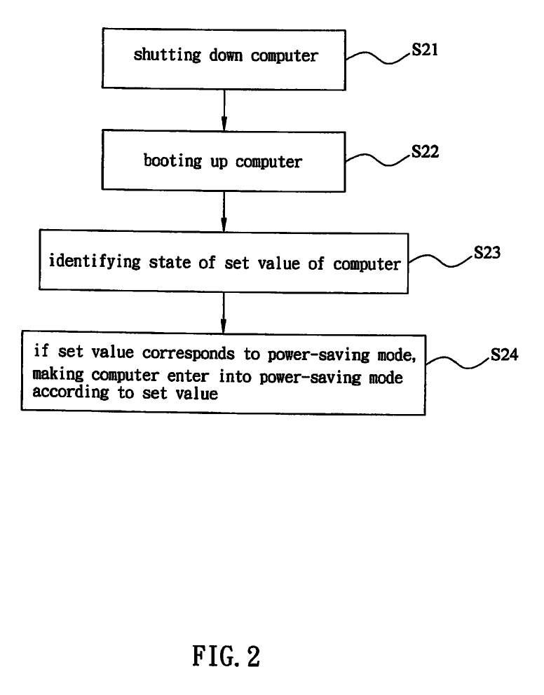

FIG. 2 is a flowchart of a method for reducing booting time of a computer according to another embodiment of the invention. Steps S21 to S24 are substantially the same as illustrated in the above embodiment. The difference is that the method in this embodiment further includes step S23 of identifying a state of a set value of the computer after the step of rebooting the computer. If the set value is a power-saving mode, the computer enters into the power-saving mode according to the set value. Thus, the computer resumes a normal state from the power-saving mode while the user boots up the computer. The set value can be stored in a secondary storage device of the computer such as a hard disk drive, or stored in the BIOS.

In the presented invention, only pluralities of seconds are spent for the computer to resume the operating state from the standby mode, and furthermore, only twenty seconds are spent for the computer to resume the operating mode from the hibernation mode. It is enough to know that the method disclosed in the presented invention can greatly reduce the conventional booting time of the computer.

According to the aforementioned, two preferred embodiments are then described in detail to illustrate how to realize the method for reducing booting time for a computer.

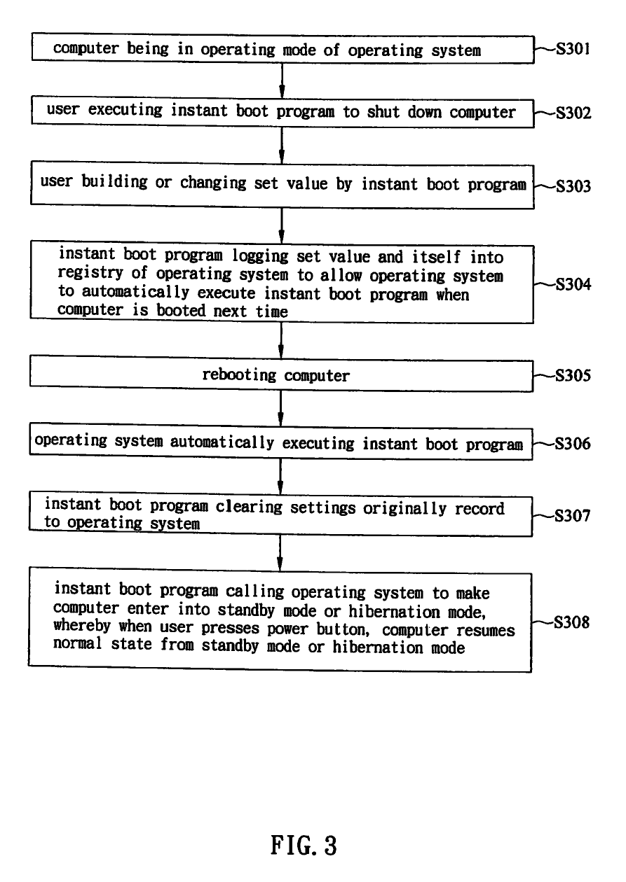

FIG. 3 is a flowchart of a method for reducing booting time according to a preferred embodiment of the invention. Referring to FIG. 3, the computer is in an operating mode (SO) of an operating system first (step S301). And then, a user executes the instant boot program to shut down the computer (step S302). After executing the instant boot program, the user builds or changes a set value via the instant boot program (step S303). For example, the user can click the option such as “setting” on the program interface and then click the field “yes, executing instant boot” after entering into the setting interface of the program. The instant boot program then changes the set value from zero to one. The way of building or changing the set value is not limited to the above description, only if the set value can be identified in the following steps.

Afterwards, the instant boot program logs the set value and itself into a registry of the operating system to allow the operating system to automatically execute the instant boot program when the computer is booted up next time (step S304) and to identify the state of the set value via the instant boot program. The set value is not limited to be stored in the registry. The set value can also be stored in a program folder as a text file.

Furthermore, the user can further click the filed such as “shutdown” after the user exits from the setting interface of the instant boot program, or the instant boot program can call the operating system to reboot the computer. After the computer is rebooted (step S305), the operating system can execute the instant boot program automatically (step S306).

Afterward the instant boot program can clear the aforementioned settings (step S307). In other words, the instant boot program can clear the setting of “automatically executing the instant boot program when the computer is booted up next time”, or makes the set value restored to zero.

The instant boot program then calls the operating system to make the computer enter into a S3 mode or a S4 mode (step S308). Thus, the computer can resume a normal state from the S3 mode or the S4 mode while the user presses the power button.

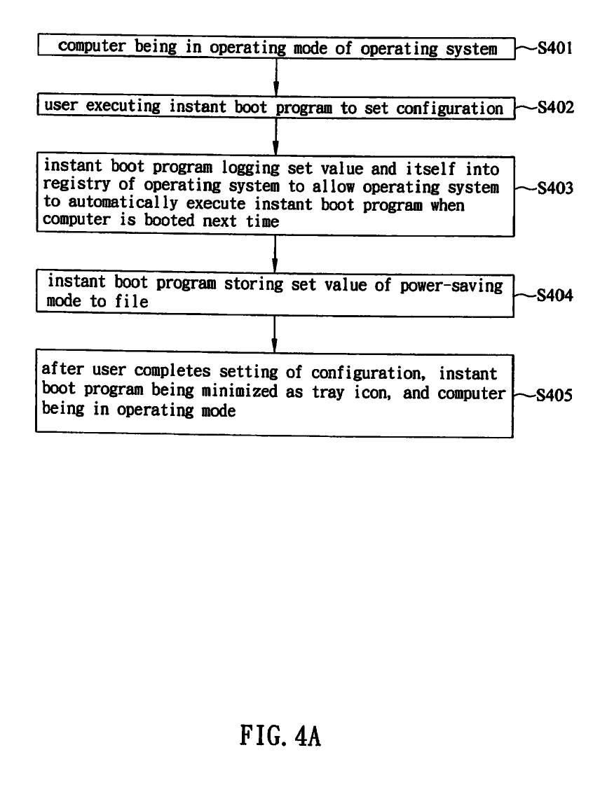

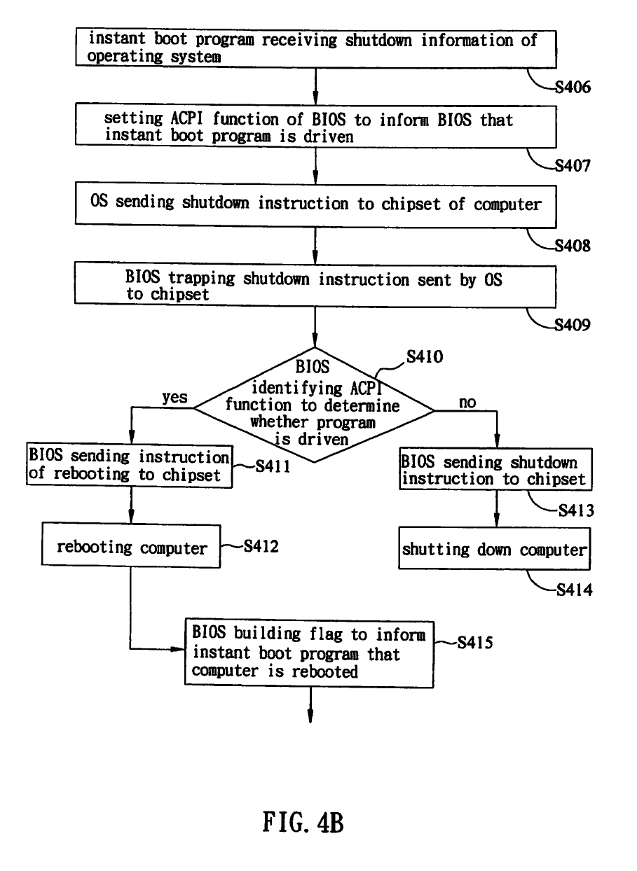

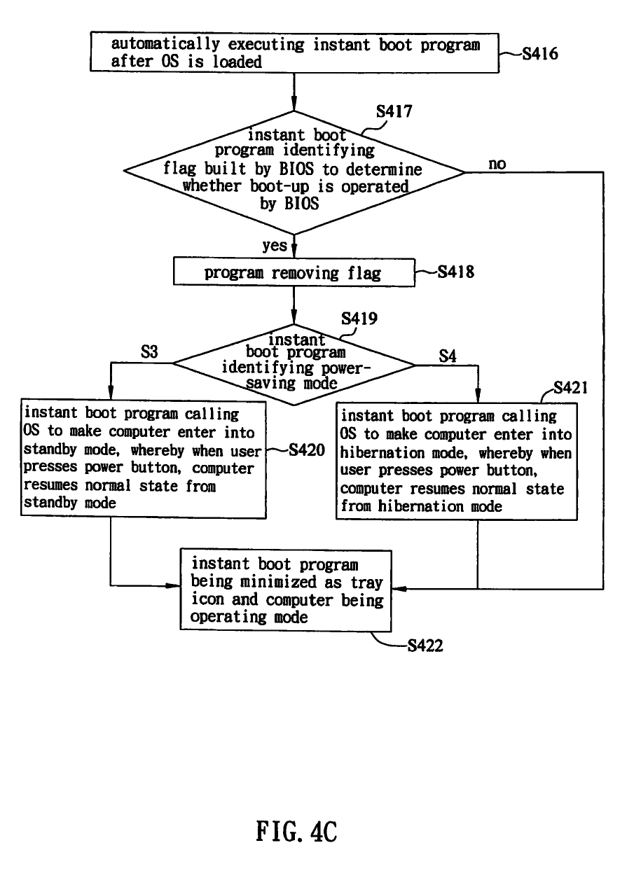

FIG. 4A is a flowchart of a method for reducing booting time of a computer according to another embodiment of the invention. In this embodiment, the method is realized by combining the function of an advanced configuration and power interface (hereinafter called “ACPI”) of the BIOS.

When the computer is in the operating mode (S0) of the operating system (step S401), the user first executes the instant boot program to set the configuration (step S402). The instant boot program then logs itself into the operating system to allow the operating system to automatically execute the instant boot program when the computer is booted up next time (step S403). In addition, the instant boot program also stores the set value of the power-saving mode as a file (step S404). Some details relative to the setting mode, the changing method or the storage method of the set value can be referred to the aforementioned. In addition, the time scales of logging the instant boot program into the operating system and building, changing, or storing the set value are not limited to any embodiment mentioned above. In other words, the time scales of them can be at the same time or different from each other.

The program is then minimized as a tray icon (step S405) after the user completes the configuration setting of the instant boot program. That is, the instant boot program exists in the operating system as a runtime program and the computer is still in the operating mode (S0) in the meanwhile. According to the embodiment of the invention, the user does not need to shut down the computer by the instant boot program; and further the step of setting the power-saving mode also does not need to be performed before the step of shutting down the computer. The step of setting the power-saving mode can be performed at a certain time after the computer is booted up or can be set to be automatically executed when the computer is booted up. According to the aforementioned, the user only needs to perform general shutdown steps, such as pressing the power button or pressing the shutdown option in the operating system, to generate a shutdown event when shutting down the computer.

Referring to FIG. 4B, the instant boot program receives the shutdown event (step S406) and sets the ACPI to inform the BIOS that the instant boot program is driven (step S407). Afterwards, the operating system sends a shutdown instruction to a chipset of the computer (step S408).

In the meanwhile, the BIOS traps the shutdown instruction (step S409) and identifies the setting of the ACPI to determine whether the instant boot program is driven (step S410). When the BIOS identifies that the instant boot program is driven, the BIOS sends an instruction of rebooting the computer to the chipset (step S411). On the contrary, the BIOS sends a shutdown instruction to the chipset (step S413) to guide the computer in executing the general shutdown program (step S414) when the BIOS identifies that the instant boot program is not driven.

After the computer is rebooted (step S412), the BIOS builds a flag to inform the instant boot program that the computer is rebooted (step S415). Please refer to FIG. 4C, after the operating system is loaded, the operating system can automatically execute the instant boot program (step S416) because the instant boot program logs itself into the operating system previously. Afterwards, the instant boot program identifies the flag built by the BIOS to determine whether the boot-up of the computer is operated by the BIOS (step S417). If yes, the flag is removed (step S418).

The instant boot program then identifies the power-saving mode set by the user (step S419) and calls the operating system to make the computer enter into a S3 mode (step S420) or a S4 mode (step S421). Thus, the computer resumes a normal state from the S3 mode or the S4 mode while the user presses the power button or performs other trigging events. After the computer resumes the normal state, the program can be minimized as the tray icon again (step S422) and exist in the operating system as a runtime program.

In addition, when the computer is rebooted, the computer can also execute other boot programs such as performing the POST, performing the initialization, recording the set value of the system, providing the runtime program library and so on.

According the disclosure of the presented invention, after the computer is shut down, the computer will be rebooted and made to enter into the power-saving mode. Thus, when the computer is booted again, the computer is directly booted up from the power-saving mode into the operating mode. As most boot programs can be omitted, the booting time is greatly reduced to achieve an instant boot effect. In addition, the operating mode of the computer enters after booted is the system state wherein the user does not start any application programs. Thus, the released memory space can be sufficiently used by the users to improve the processing performance of the computer.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for reducing booting time of a computer, comprising the steps of:
shutting down the computer;
rebooting the computer; and
making the computer enter into a power-saving mode,
whereby when a user performs an operation to boot up the computer, the computer resumes a normal state from the power-saving mode.

2. The method according to claim 1, wherein before the step of shutting down the computer, the method further comprises the step of:
receiving a set value of the power-saving mode.

3. The method according to claim 2, further comprising the step of:
storing the set value to a secondary storage device of the computer.

4. The method according to claim 2, further comprising the step of:
storing the set value to a BIOS of the computer.

5. The method according to claim 2, wherein during the step of making the computer enter into the power-saving mode, the computer enters into the power-saving mode according to the set value.

6. The method according to claim 1, wherein the step of rebooting up the computer further comprises the step of:
loading an operating system into the computer.

7. The method according to claim 1, wherein before the step of shutting down the computer, the method further comprises the step of:
waiting for a shutdown event.

8. The method according to claim 1, wherein the power-saving mode is a standby mode.

9. The method according to claim 1, wherein the power-saving mode is a hibernation mode.

10. A method for reducing booting time of a computer, the method comprising the steps of:
shutting down the computer;
rebooting up the computer;
identifying a state of a set value of the computer; and
if the set value corresponds to a power-saving mode, making the computer enter into the power-saving mode according to the set value, whereby the computer resumes a normal state from the power-saving mode while a user performs an operation to boot up the computer.

11. The method according to claim 10, wherein before the step of shutting down the computer, the method further comprises the step of:
receiving the set value.

12. The method according to claim 11, further comprising the step of:
storing the set value to a secondary storage device of the computer.

13. The method according to claim 11, further comprising the step of:
storing the set value to a BIOS of the computer.

14. The method according to claim 10, wherein before the step of shutting down the computer, the method further comprises the step of:
waiting for a shutdown event.

15. The method according to claim 10, wherein the step of rebooting up the computer further comprises the step of:
loading an operating system into the computer.

16. The method according to claim 10, wherein the power-saving mode is a standby mode.

17. The method according to claim 10, wherein the power-saving mode is a hibernation mode.

18. A computer comprising:
an operating system for making the computer enter into a power-saving mode after the computer is shut down and rebooted, whereby the computer resumes a normal state from the power-saving mode while a user performs an operation to boot up the computer.

19. The computer according to claim 18, wherein the computer further comprises an instant boot program for setting a set value of the power-saving mode.

20. The computer according to claim 19, wherein the computer further comprises a secondary storage device for storing the set value of the power-saving mode.

21. The computer according to claim 19, wherein the computer further comprises a BIOS for storing the set value of the power-saving mode.

22. The computer according to claim 21, further comprising a chipset, wherein the BIOS informs the chipset and makes the computer reboot via the chipset while the BIOS receives the set value of the power-saving mode.

23. The computer according to claim 19, wherein the instant boot program logs itself into the operating system while the instant boot program is executed.
